(19) United States
(12) Patent Application Publication
(10) Pub. No.: US 2015/0121077 A1
(43) Pub. Date: Apr. 30, 2015

(54) METHOD AND APPARATUS FOR CONTROLLING LOCK STATE IN ELECTRONIC DEVICE SUPPORTING WIRELESS COMMUNICATION AND SYSTEM THEREFOR

(71) Applicant: Samsung Electronics Co., Ltd., Suwon-si (KR)

(72) Inventors: Bumhan KIM, Yongin-si (KR); Chankyu HAN, Seoul (KR); Michael PARK, Seoul (KR)

(21) Appl. No.: 14/522,881

(22) Filed: Oct. 24, 2014

(30) Foreign Application Priority Data
Oct. 25, 2013 (KR) 10-2013-0127994

(51) Int. Cl. H04L 9/32; H04W 12/08; H04L 29/06

(52) U.S. Cl. CPC H04L 9/3268; H04L 63/0823; H04L 63/062; H04W 12/08
USPC 713/173

(57) ABSTRACT

A method and an apparatus for controlling a lock state of an electronic device, and a system therefor are provided. The method includes signing a lock state update request by using a unique key loaded in a confidence region of the electronic device when a lock state change is requested, generating a lock state control request message including the lock state update request, the signed lock state update request, and a certificate of the electronic device, transmitting the generated lock state control request message to a service provider server, and authenticating a lock state update command in a communication processor of the electronic device and updating a state of the communication processor according to the lock state update command when the lock state update command is received from the service provider server.

### CROSS-REFERENCE TO RELATED APPLICATION(S)

This application claims the benefit under 35 U.S.C. §119(a) of a Korean patent application filed on Oct. 25, 2013 in the Korean Intellectual Property Office and assigned Serial number 10-2013-0127994, the entire disclosure of which is hereby incorporated by reference.

### TECHNICAL FIELD

The present disclosure relates to a method and an apparatus for controlling a lock state in an electronic device. More particularly, the present disclosure relates to a method and an apparatus for controlling a lock state by using a confidence region of an electronic device that supports wireless communication, and a system therefor.

### BACKGROUND

Recently, various electronic devices that support wireless communication have been released on the market. These electronic devices that support wireless communication may include, for example, a notebook computer, a tablet computer, a feature phone, a smart phone, etc.

For the electronic devices that support wireless communication, the most important function is to provide security. For example, a communication that is not desired by a user can be performed if the user's electronic device that supports wireless communication is lost or intentionally modified by another person, and thereby the user may suffer a great loss. Moreover, if an electronic device that supports electronic commerce is illegally used after being lost or intentionally modified by another person, a financial loss can be suffered by the owner of the electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages to provide at least advantages described below. Accordingly, an aspect of the present disclosure is to provide a method, apparatus, and system for preventing an illegal use of an electronic device supporting wireless communication.

Another aspect of the present disclosure is to provide a method, apparatus, and system for controlling a lock state of an electronic device for a mobile communication subscriber in wireless communication.

Another aspect of the present disclosure is to provide a method, apparatus, and system for controlling a lock state of an electronic device by using individually different confidence regions in the electronic device supporting wireless communication.

In accordance with an aspect of the present disclosure, a method for controlling a lock state in an electronic device is provided. The method includes signing a lock state update request by using a unique key loaded in a confidence region of the electronic device when a lock state change is requested, generating a lock state control request message including the lock state update request, the signed lock state update request, and a certificate of the electronic device, transmitting the generated lock state control request message to a service provider server, authenticating a lock state update command in a communication processor of the electronic device, and updating a state of the communication processor according to the lock state update command when the lock state update command is received from the service provider server.

In accordance with another aspect of the present disclosure, an apparatus for controlling a lock state in an electronic device is provided. The apparatus includes a communication module configured to communicate with a service provider server, and an application processor configured to sign a lock state update request by using a unique key loaded in a confidence region of the electronic device when a lock state change is requested, to generate a lock state control request message including the lock state update request, the signed lock state update request, and a certificate of the electronic device, and to transmit a lock state update command to a communication processor when the lock state update command is received, wherein the communication processor is configured to control to transmit the lock state control request message generated by the application processor to the service provider server through the communication module, to authenticate the lock state update command through a pre-loaded certificate provided by the service provider server when the lock state update command is received, and to change a lock state according to the lock state update command when the lock state update command is authenticated.

In accordance with another aspect of the present disclosure, a system for controlling a lock state in an electronic device is provided. The system includes an electronic device and a service provider server. The electronic device includes a communication module configured to communicate with the service provider server, and an application processor configured to sign a lock state update request by using a unique key loaded in a confidence region of the electronic device when a lock state change is requested, to generate a lock state control request message including the lock state update request, the signed lock state update request, and a certificate of the electronic device, and to transmit a lock state update command to a communication processor when the lock state update command is received, wherein the communication processor is configured to control to transmit the lock state control request message generated by the application processor to the service provider server through the communication module, to authenticate the lock state update command through a pre-loaded certificate provided by the service provider server when the lock state update command is received, and to change a lock state of the electronic device according to the lock state update command when the lock state update command is authenticated. The service provider server includes a subscriber database configured to store the certificate of the electronic device provided by a manufacturer producing the electronic device and a public key provided by the service provider server, and a server configured to verify the lock state control request message by using the certificate stored in the subscriber database when the lock state control request message is received through a network, and to generate the lock state update command for changing a lock state of the electronic device in order to transmit the lock state update command to the electronic device through the network when the lock state control request message is verified.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic drawing illustrating a system configuration for locking and unlocking an electronic device according to an embodiment of the present disclosure;

FIG. 2 is a block diagram illustrating a configuration of an electronic device and an external connection according to an embodiment of the present disclosure;

FIG. 3 is a block diagram illustrating a configuration of an electronic device having internal hardware blocks according to an embodiment of the present disclosure;

FIG. 4 is a flowchart illustrating security processing of an electronic device produced between a service provider and an electronic device manufacturer according to an embodiment of the present disclosure; and

FIG. 5 is a flowchart illustrating signal flows generated while locking and unlocking an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or “have” may be construed to denote a certain characteristic, number, step, operation, constituent element, component or a combination thereof, but may not be construed to exclude the existence of or a possibility of an addition of one or more other characteristics, numbers, steps, operations, constituent elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them are user devices. For example, a first element could be termed a second element, and similarly, a second element could be also termed a first element without departing from the scope of the present disclosure.

In a case where a component is referred to as being “connected” or “accessed” to another component, it should be understood that not only may the component be directly connected or accessed to the other component, but also there may exist another component between them. Meanwhile, in a case where a component is referred to as being “directly connected” or “directly accessed” to another component, it should be understood that there is no component therebetween. The terms used in the present disclosure are only used to describe specific various embodiments, and are not intended to limit the present disclosure. As used herein, the singular forms are intended to include the plural forms as well, unless the context clearly indicates otherwise. Singular forms are intended to include plural forms unless the context clearly indicates otherwise.

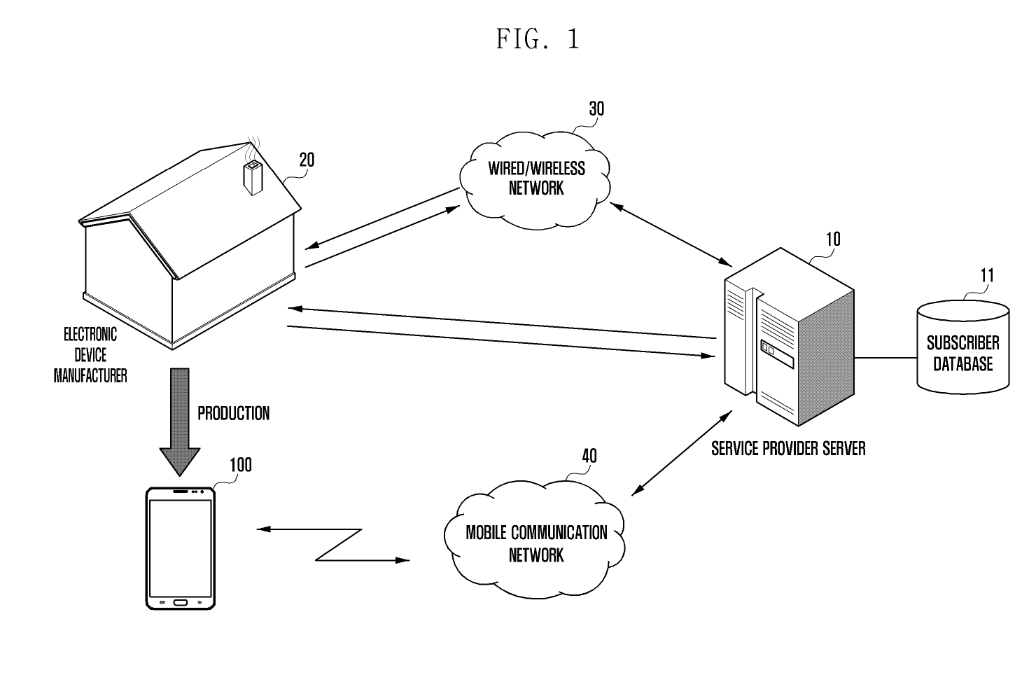

FIGS. 1 through 5, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 is a schematic drawing illustrating a system configuration for locking and unlocking an electronic device according to an embodiment of the present disclosure.

Referring to FIG. 1, a system, which is largely divided into an electronic device manufacturer 20, a service provider server 10 of a service provider, and an electronic device 100 produced by the electronic device manufacturer 20, is shown. The electronic device manufacturer 20 and the service provider server 10 exchange a public key certificate with each other to gain confidence. In order to exchange the public key certificate between the electronic device manufacturer 20 and the service provider server 10, the public key certificate may be exchanged by meeting each other or by an e-mail through a wired/wireless network 30, as shown in FIG. 1.

The service provider server 10 generates a public key, and the generated public key may be stored in a subscriber database 11 of the service provider server 10. Further, by using the generated public key, a public key certificate (Public Key Cert) can be prepared to be provided to the electronic device manufacturer 20. Here, the public key certificate generated by the service provider server 10 can be directly handed over to the electronic device manufacturer 20 or transmitted by an e-mail through the wired/wireless network 30. Accordingly, the electronic device manufacturer 20 can load the public key certificate provided by the service provider server 10 into the produced electronic devices, such as the electronic device 100.

The electronic device manufacturer 20 generates a public key also, and can generate a public key certificate (Public Key Root Cert) by using the public key. The electronic device manufacturer 20 provides the generated public key certificate (Public Key Root Cert) to the service provider server 10. For this, the electronic device manufacturer 20 may directly hand the generated public key certificate over to the service provider server 10 or transmit the generated public key certificate by an e-mail through the wired/wireless network 30. The service provider server 10 can store the public key certificate received from the electronic device manufacturer 20 in the subscriber database 11 of the service provider server 10.

The public key certificate generated and exchanged between the service provider server 10 and the electronic device manufacturer 20 can be used for locking and unlocking the electronic device 100 according to the present disclosure.

As described above, the electronic device 100 can be loaded with a public key certificate provided by the service provider server 10, and each electronic device, such as the electronic device 100, can be loaded with a differently set unique key. The unique key set differently for each electronic device is an input value generated by the electronic device manufacturer 20, and loaded into a confidence region (trust zone) of the electronic devices, such as the electronic device 100. The unique key set differently for each electronic device is loaded in the confidence region, and thereby can be accessed by a specific program or an application (or app) available in the confidence region.

The electronic device 100 according to an embodiment of the present disclosure may be provided with a wireless communication service from the service provider and may be loaded with the aforementioned information. The electronic device 100 according to an embodiment of the present disclosure may be a device including a communication function for communicating to the service provider server 10 on a mobile communication network 40. For example, the device corresponds to a combination of at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player, a mobile medical device, an electronic bracelet, an electronic necklace, an electronic accessory, a camera, a wearable device, an electronic clock, a wrist watch, home appliances (for example, an air-conditioner, vacuum, an oven, a microwave, a washing machine, an air cleaner, and the like), an artificial intelligence robot, a TeleVision (TV), a Digital Video Disk (DVD) player, an audio device, various medical devices (for example, Magnetic Resonance Angiography (MRA), Magnetic Resonance Imaging (MRI), Computed Tomography (CT), a scanning machine, a ultrasonic wave device, or the like), a navigation device, a Global Positioning System (GPS) receiver, an Event Data Recorder (EDR), a Flight Data Recorder (FDR), a set-top box, a TV box (for example, Samsung HomeSync™, Apple TV™, or Google TV™), an electronic dictionary, vehicle infotainment device, an electronic equipment for a ship (for example, navigation equipment for a ship, gyrocompass, or the like), avionics, a security device, electronic clothes, an electronic key, a camcorder, game consoles, a Head-Mounted Display (HMD), a flat panel display device, an electronic frame, an electronic album, furniture or a portion of a building/structure that includes a communication function, an electronic board, an electronic signature receiving device, a projector, and the like. It is obvious to those skilled in the art that the electronic device according to the present disclosure is not limited to the aforementioned devices.

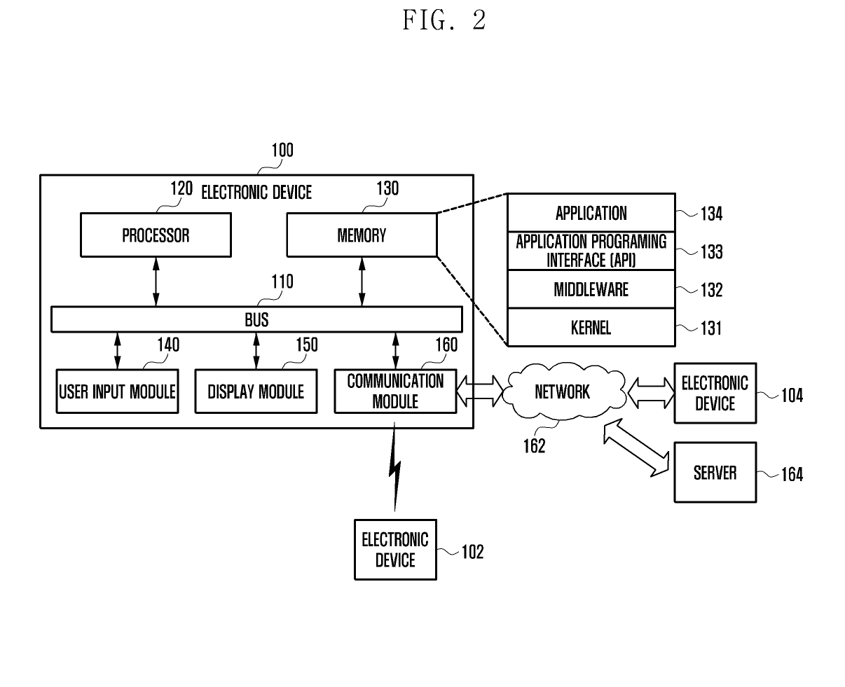

FIG. 2 is a block diagram illustrating a configuration of an electronic device and an external connection according to an embodiment of the present disclosure.

Referring to FIG. 2, an electronic device 100 may include a bus 110, a processor 120, a memory 130, a user input module 140, a display module 150, a communication module 160, and other similar and/or suitable components.

The bus 110 may be a circuit which interconnects the above-described elements and delivers a communication (e.g., a control message) between the above-described elements.

The processor 120 may receive commands from the above-described other elements (e.g., the memory 130, the user input module 140, the display module 150, the communication module 160, etc.) through the bus 110, may interpret the received commands, and may execute calculation or data processing according to the interpreted commands. Further, the processor 120 can perform an operation for locking or unlocking the electronic device 100 according to the present disclosure.

The memory 130 can store commands or data generated and received from the processor 120 or other components such as the user input module 140, the display module 150, and the communication module 160.

The memory 130 may store commands or data received from the processor 120 or other elements (e.g., the user input module 140, the display module 150, the communication module 160, etc.) or generated by the processor 120 or the other elements. The memory 130 may include programming modules, such as a kernel 131, middleware 132, an Application Programming Interface (API) 133, an application 134, and the like. Each of the above-described programming modules may be implemented in software, firmware, hardware, or a combination of two or more thereof.

The kernel 131 may control or manage system resources (e.g., the bus 110, the processor 120, the memory 130, etc.) used to execute operations or functions implemented by other programming modules (e.g., the middleware 132, the API 133, and the application 134). Also, the kernel 131 may provide an interface capable of accessing and controlling or managing the individual elements of the electronic device 100 by using the middleware 132, the API 133, or the application 134.

The middleware 132 may serve to go between the API 133 or the application 134 and the kernel 131 in such a manner that the API 133 or the application 134 communicates with the kernel 131 and exchanges data therewith. Also, in relation to work requests received from one or more applications (e.g., the application 134) and/or the middleware 132, for example, a load balancing of the work requests may be performed by using a method of assigning a priority, in which system resources (e.g., the bus 110, the processor 120, the memory 130, etc.) of the electronic device 100 can be used, to at least one of the one or more applications (e.g., the application 134).

The API 133 is an interface through which the application 134 is capable of controlling a function provided by the kernel 131 or the middleware 132, and may include, for example, at least one interface or function for file control, window control, image processing, character control, or the like.

The user input module 140, for example, may receive a command or data as input from a user, and may deliver the received command or data to the processor 120 or the memory 130 through the bus 110. The display module 150 may display a video, an image, data, or the like to the user.

The communication module 160 may directly connect a communication with another electronic device 102 or connect a communication with another electronic device 104 through a network 162. Here, the network 162 may include the wired/wireless network 30 and the mobile communication network 40 shown in FIG. 1. When the communication module 160 connects a communication with another electronic device 102, the communication module 160 may be connected through a Local Area Network (LAN) communication protocol such as a Wireless Fidelity (Wi-Fi), Bluetooth (BT), and Near Field Communication (NFC). Further, the communication module 160 can communicate with another electronic device 104 through the network 162 such as Internet, LAN, Wide Area Network (WAN), telecommunication network, cellular network, satellite network, and Plain Old Telephone Service (POTS).

The electronic devices 102 and 104 shown in FIG. 2 may be of the same type as the electronic device 100 or may be of a different type than the electronic device 100. Further, the communication module 160 may connect communication between a server 164 and the electronic device 100 via the network 162.

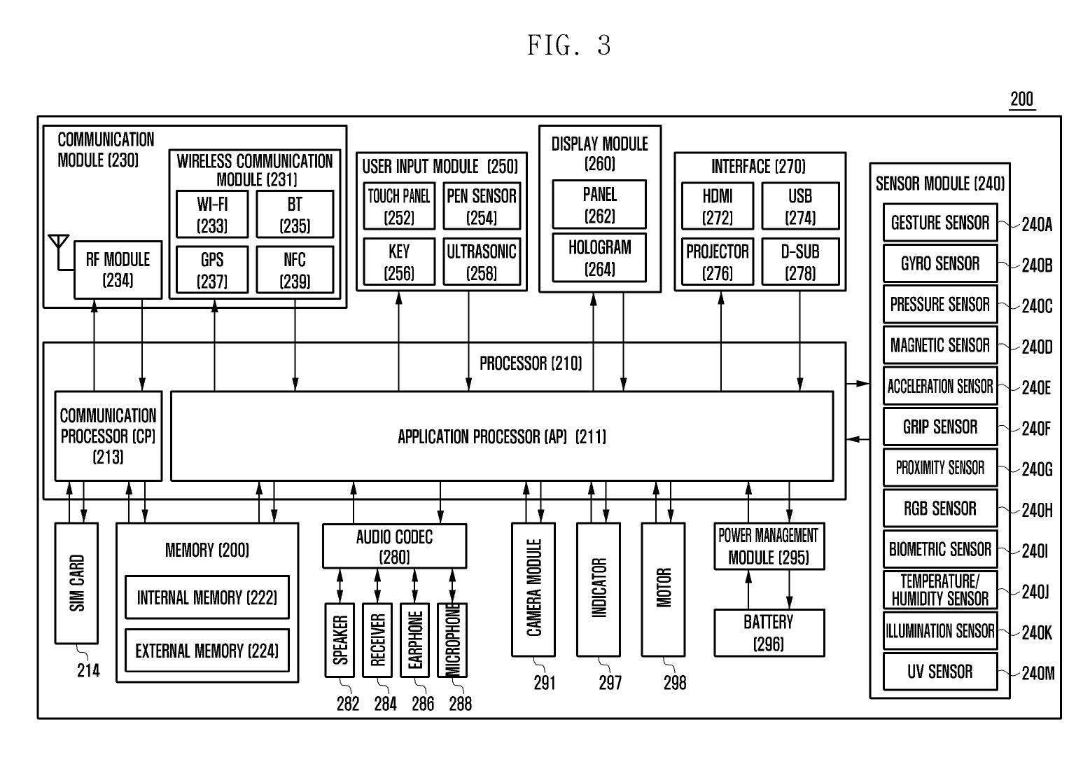

FIG. 3 is a block diagram illustrating a configuration of an electronic device having internal hardware blocks according to an embodiment of the present disclosure.

Referring to FIG. 3, an electronic device 200 may be, for example, the electronic device 100 illustrated in FIG. 1 or FIG. 2. Furthermore, referring to FIG. 3, the electronic device 200 may include one or more processors 210, a Subscriber Identification Module (SIM) card 214, a memory 200, a communication module 230, a sensor module 240, a user input module 250, a display module 260, an interface 270, an audio coder/decoder (codec) 280, a camera module 291, a power management module 295, a battery 296, an indicator 297, a motor 298 and any other similar and/or suitable components.

The processor 210 may include one or more Application Processors (APs) 211, or one or more Communication Processors (CPs) 213. The processor 210 may be, for example, the processor 120, as illustrated in FIG. 2. The AP 211 and the CP 213 are illustrated as being included in the processor 210 in FIG. 3, but may be included in different Integrated Circuit (IC) packages, respectively. According to an embodiment of the present disclosure, the AP 211 and the CP 213 may be included in one IC package.

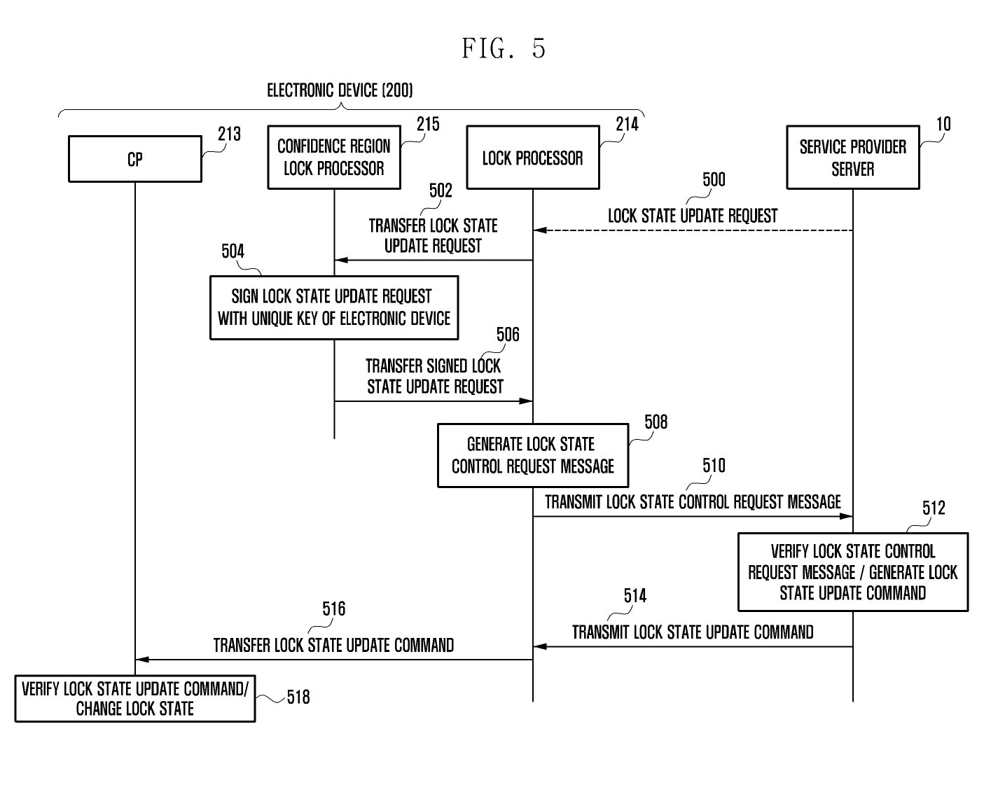

The AP 211 may execute an Operating System (OS) or an application program, and thereby may control multiple hardware or software elements connected to the AP 211 and may perform processing of arithmetic operations on various data including multimedia data. The AP 211 may be implemented by, for example, a System on Chip (SoC). According to an embodiment of the present disclosure, the processor 210 may further include a Graphical Processing Unit (GPU) (not illustrated). Further, programs (e.g., applications, or modules) being driven in the AP 211 are supported by the present disclosure. The AP 211 may internally include a lock processor and a confidence region lock processor. The lock processor may include a program for processing a lock state of the electronic device 200 when a lock state update request is received from a user or through a network. The confidence region lock processor may perform a control required for processing the lock state in a confidence region according to the present disclosure. Operations of the lock processor and the confidence region lock processor are described in more detail referring to the flowchart illustrated in FIG. 5.

The CP 213 may manage a data line and may convert a communication protocol in a case of communication between the electronic device 200 (e.g., the electronic device 100, as illustrated in FIGS. 1 and 2) and different electronic devices connected to the electronic device 200 through the network. The CP 213 may be implemented by, for example, a SoC. According to an embodiment of the present disclosure, the CP 213 may perform at least some of multimedia control functions. The CP 213, for example, may distinguish and authenticate a terminal in a communication network by using a subscriber identification module (e.g., the SIM card 214). Also, the CP 213 may provide the user with services, such as a voice telephony call, a video telephony call, a text message, packet data, and the like. Further, the CP 213 can load the public key certificate provided by the service provider server 10, as illustrated in FIG. 1, in a binary form such as a firmware type.

Further, the CP 213 can control data communication of the communication module 230. Referring to FIG. 3, components such as the CP 213, the power management module 295, and the memory 200 are illustrated separately from the AP 211, but the AP 211 may be configured to include at least one of the above components (for example, the CP 213) according to another embodiment.

According to an embodiment of the present disclosure, the AP 211 or the CP 213 may load, to a volatile memory, a command or data received from at least one of a non-volatile memory and other elements connected to each of the AP 211 and the CP 213, and may process the loaded command or data. Also, the AP 211 or the CP 213 may store, in a non-volatile memory, data received from or generated by at least one of the other elements.

The SIM card 214 may be a card implementing a subscriber identification module, and may be inserted into a slot formed in a particular portion of the electronic device 200. The SIM card 214 may include unique identification information (e.g., an Integrated Circuit Card IDentifier (ICCID)) or subscriber information (e.g., an International Mobile Subscriber Identity (IMSI)). Further, the SIM card 214 may include device unique keys for each of electronic devices.

The memory 200 may include an internal memory 222 and an external memory 224. The memory 200 may be, for example, the memory 130, as illustrated in FIG. 2. The internal memory 222 may include, for example, at least one of a volatile memory (e.g., a Dynamic Random Access Memory (DRAM), a Static RAM (SRAM), a Synchronous Dynamic RAM (SDRAM), etc.), and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, a Not OR (NOR) flash memory, etc.). According to an embodiment of the present disclosure, the internal memory 222 may be in the form of a Solid State Drive (SSD). The external memory 224 may further include a flash drive, for example, a Compact Flash (CF), a Secure Digital (SD), a Micro-Secure Digital (Micro-SD), a Mini-Secure Digital (Mini-SD), an extreme Digital (xD), a memory stick, or the like.

The communication module 230 may include a wireless communication module 231 or a Radio Frequency (RF) module 234. The communication module 230 may be, for example, the communication module 160, as illustrated in FIG. 2. The wireless communication module 231 may include, for example, a Wi-Fi part 233, a BT part 235, a GPS part 237, or a NFC part 239. For example, the wireless communication module 231 may provide a wireless communication function by using a radio frequency. Additionally or alternatively, the wireless communication module 231 may include a network interface (e.g., a LAN card), a modulator/demodulator (modem), or the like for connecting the electronic device 200 to a network (e.g., the Internet, a LAN, a WAN, a telecommunication network, a cellular network, a satellite network, a POTS, or the like).

The RF module 234 may be used for transmission and reception of data, for example, the transmission and reception of RF signals or called electronic signals. Although not illustrated, the RF unit 234 may include, for example, a transceiver, a Power Amplifier Module (PAM), a frequency filter, a Low Noise Amplifier (LNA), or the like. Also, the RF module 234 may further include a component for transmitting and receiving electromagnetic waves in a free space in a wireless communication, for example, a conductor, a conductive wire, or the like.

The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a Red, Green and Blue (RGB) sensor 240H, a biometric sensor 240I, a temperature/humidity sensor 240J, an illuminance (e.g., illumination) sensor 240K, and a Ultra Violet (UV) sensor 240M. The sensor module 240 may measure a physical quantity or may sense an operating state of the electronic device 200, and may convert the measured or sensed information to an electrical signal. Additionally/alternatively, the sensor module 240 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), a fingerprint sensor (not illustrated), and the like. The sensor module 240 may further include a control circuit (not illustrated) for controlling one or more sensors included therein.

The user input module 250 may include a touch panel 252, a pen sensor 254 (e.g., a digital pen sensor), keys 256, and an ultrasonic input unit 258. The user input module 250 may be, for example, the user input module 140, as illustrated in FIG. 2. The touch panel 252 may recognize a touch input in at least one of, for example, a capacitive scheme, a resistive scheme, an infrared scheme, and an acoustic wave scheme. Also, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input unit 258 enables the terminal to sense a sound wave by using a microphone (e.g., a microphone 288) of the terminal through a pen generating an ultrasonic signal, and to identify data. The ultrasonic input unit 258 is capable of wireless recognition. According to an embodiment of the present disclosure, the electronic device 200 may receive a user input from an external device (e.g., a network, a computer, or a server), which is connected to the communication module 230, through the communication module 230.

The display module 260 may include a panel 262 or a hologram 264. The display module 260 may be, for example, the display module 150, as illustrated in FIG. 2. The panel 262 may be, for example, a Liquid Crystal Display (LCD) and an Active Matrix Organic Light Emitting Diode (AM-OLED) display, and the like. The panel 262 may be implemented so as to be, for example, flexible, transparent, or wearable. The panel 262 may include the touch panel 252 and one module. The hologram 264 may display a three-dimensional image in the air by using interference of light. According to an embodiment of the present disclosure, the display module 260 may further include a control circuit for controlling the panel 262 or the hologram 264.

The interface 270 may include, for example, a High-Definition Multimedia Interface (HDMI) 272, a Universal Serial Bus (USB) 274, a projector 276, and a D-subminiature (D-sub) 278. Additionally or alternatively, the interface 270 may include, for example, a SD/Multi-Media Card (MMC) (not illustrated) or an Infrared Data Association (IrDA) (not illustrated).

The audio codec 280 may bi-directionally convert between a voice and an electrical signal. The audio codec 280 may convert voice information, which is input to or output from the audio codec 280, through, for example, a speaker 282, a receiver 284, an earphone 286, the microphone 288 or the like.

The camera module 291 may capture an image and a moving image. According to an embodiment, the camera module 291 may include one or more image sensors (e.g., a front lens or a back lens), an Image Signal Processor (ISP) (not illustrated), and a flash LED (not illustrated).

The power management module 295 may manage power of the electronic device 200. Although not illustrated, the power management module 295 may include, for example, a Power Management Integrated Circuit (PMIC), a charger Integrated Circuit (IC), or a battery fuel gauge.

The PMIC may be mounted to, for example, an IC or a SoC semiconductor. Charging methods may be classified into a wired charging method and a wireless charging method. The charger IC may charge a battery, and may prevent an overvoltage or an over current from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, etc.) for wireless charging may be added in order to perform the wireless charging.

The battery fuel gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the electronic device 200 or a part (e.g., the AP 211) of the electronic device 200, for example, a booting state, a message state, a charging state and the like. The motor 298 may convert an electrical signal into a mechanical vibration. The processor 210 may control the sensor module 240.

Although not illustrated, the electronic device 200 may include a processing unit (e.g., a GPU) for supporting a module TV. The processing unit for supporting the module TV may process media data according to standards such as, for example, Digital Multimedia Broadcasting (DMB), Digital Video Broadcasting (DVB), media flow, and the like. Each of the above-described elements of the electronic device 200 according to an embodiment of the present disclosure may include one or more components, and the name of the relevant element may change depending on the type of the electronic device 200. The electronic device 200 according to an embodiment of the present disclosure may include at least one of the above-described elements. Some of the above-described elements may be omitted from the electronic device 200, or the electronic device 200 may further include additional elements. Also, some of the elements of the electronic device 200 according to an embodiment of the present disclosure may be combined into one entity, which may perform functions identical to those of the relevant elements before the combination.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof. The “module” may be a minimum unit for performing one or more functions or a part thereof. The “module” may be implemented mechanically or electronically. For example, the “module” according to an embodiment of the present disclosure may include at least one of an Application-Specific Integrated Circuit (ASIC) chip, a Field-Programmable Gate Array (FPGA), and a programmable-logic device for performing certain operations which have been known or are to be developed in the future.

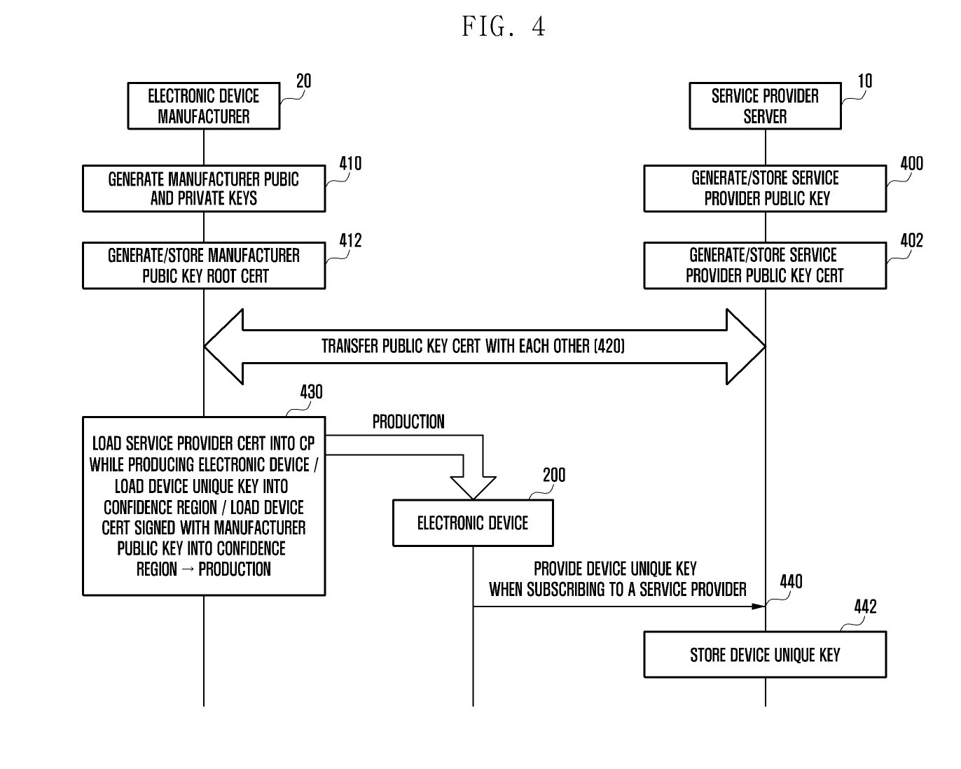

FIG. 4 is a flowchart illustrating security processing of an electronic device produced between a service provider and an electronic device manufacturer according to an embodiment of the present disclosure.

Referring to FIG. 4, a service provider generates/stores a service provider public key by using a service provider server 10, a separate server, a system, or a computer at operation 400. An example of utilizing the service provider server 10 is illustrated in FIG. 4. The service provider public key can be stored in the user database 11 connected to the service provider server 10, as illustrated in FIG. 1.

Further, after generating the service provider public key, the service provider generates/stores a service provider public key cert from the service provider public key by using the service provider server 10 at operation 402. The present disclosure is not limited by specific restrictions in generating the public key and public key certificate. Accordingly, all of the public keys currently known and to be developed in the future can be applied. The generated service provider public key cert can be stored in the user database 11 connected to the service provider server 10, as illustrated in FIG. 1, at operation 402.

In the meantime, the electronic device manufacturer 20 generates a manufacturer public key and a manufacture private key by using a specific server, system, or computer at operation 410. The electronic device manufacturer 20 can store and manage the generated manufacturer public key in a predetermined server or system.

Further, after generating the manufacturer public key, the electronic device manufacturer 20 generates/stores a manufacture public key root cert from the manufacturer public key by using a specific server, system, or computer at operation 412. The present disclosure is not limited by specific restrictions to generating the public key and the public key certificate. Accordingly, all of the public keys currently known and to be developed in the future can be applied. The generated manufacturer public key root cert can be stored in a specific server or system at operation 412.

Referring to FIG. 4, the operations performed by the service provider server 10 are denoted as 400 and 402, and the operations performed by the electronic device manufacturer 20 are denoted as 410 and 412. Even though these numbers are denoted as operations of the service provider server 10, this is merely for convenience of description and there may be actually no time difference therebetween. Namely, the electronic device manufacturer 20 may generate the public key earlier than the service provider server 10 or the service provider server 10 and the electronic device manufacturer 20 may generate the public key at the same time.

After individually generating the public key and public key certificate, the service provider server 10 and the electronic device manufacturer 20 exchange the public key certificate with each other at operation 420. Namely, the service provider server 10 provides a service provider public key cert for the electronic device manufacturer 20 and the electronic device manufacturer 20 provides a manufacture public key root cert for the service provider server 10. Accordingly, the service provider server 10 can store the manufacture public key root cert received from the electronic device manufacturer 20 in the subscriber database 11 connected to the service provider server 10, as illustrated in FIG. 1. Further, the electronic device manufacturer 20 can produce an electronic device by using the service provider public key cert received from the service provider server 10.

While producing the electronic device, the electronic device manufacturer 20 loads the service provider public key cert into the communication processer (CP) 213, as illustrated in FIG. 2, and an individually different device unique key into each electronic device at operation 430. Here, the service provider public key cert may be loaded into an electronic device in a binary form. For example, while producing electronic devices, the service provider public key cert may be loaded into an electronic device in a firmware form or stored in a memory by encrypting. Loading differently allocated unique keys into each electronic device means storing in a binary form. For example, the service provider public key cert may be loaded into an electronic device in a firmware form while producing the electronic device. Further, the electronic device manufacturer 20 loads a device certificate signed with the manufacturer public key in a confidence region at operation 430.

When subscribing to a service provider, individually different unique keys assigned to each electronic device may be provided for the electronic device 200 produced through the above process at operation 440. Further, the electronic device 200 can be configured not to use a unique key according to an agreement between the service provider server 10 and the electronic device manufacturer 20 at operation 440. If individually different unique keys assigned to each electronic device are provided for subscribing to the service provider, the service provider server 10 stores the unique key of the electronic device 200 in the subscriber database 11 connected to the service provider server 10, as illustrated in FIGS. 1 and 2, at operation 442.

FIG. 5 is a flowchart illustrating signal flows generated while locking and unlocking an electronic device according to an embodiment of the present disclosure.

Components of an electronic device are illustrated in FIG. 5, according to an embodiment of the present disclosure. These components may be part of any of the electronic devices shown in FIGS. 1 to 3, or may be part of an electronic device produced for executing the method of FIG. 4. For the description of the flowchart in FIG. 5, the configuration of the electronic device 200, as illustrated in FIG. 3, is assumed to be used.

The electronic device 200 and the service provider server 10 illustrated in FIG. 3 may be loaded with a service provider public key cert provided by the service provider in a CP 213 in a binary firmware form or in a specific area of a memory 200, as illustrated in FIG. 3, accessible only by the CP 213, for example, a confidence region (trust zone of CP). If the public key cert is loaded in the CP 213 in a binary form, the integrity of the CP 213 can be secured hardware-wise. Securing the integrity of the CP 213 means that binaries loaded in the CP 213 cannot be modified by hacking. Accordingly, the public key provided by the service provider cannot be changed and the CP 213 can detect whether data provided by the service provider is normal or contains errors due to hacking.

Further, whenever producing electronic devices, the electronic device manufacturer 20, as illustrated in FIG. 1, stores individually different device unique keys for each electronic device in the confidence region (trust zone), for example, in a specific area allocated to the memory 200 as a confidence region or in a SIM card 216, as illustrated in FIG. 3. As a result, the electronic device 200 becomes completely finished and ready to receive services from a specific service provider.

Referring to FIG. 5, a lock processor 214 is illustrated, where the lock processor 214 receives a lock state update request of the electronic device 200 at operation 500. Here, the lock state update request may be received from the service provider server 10 through a specific network such as a mobile communication network 40, as illustrated in FIG. 1, or a user or a supervisor of service provider may directly request by operating the user input module 250, as illustrated in FIG. 3, of the electronic device 200. FIG. 5 illustrates a case of receiving the lock state update request from the service provider server 10 through a specific network, and descriptions will be followed based on this.

If the lock state update request is received at operation 500, the lock processor 214 transmits the lock state update request to a confidence region lock processor 215. Because the lock processor 214 is not driven in the confidence region (trust zone), the lock processor 214 cannot access a unique terminal key loaded in the electronic device 200. Therefore, the lock processor 214 transmits the lock state update request to the confidence region lock processor 215 in operation 502 so that a locking operation of the electronic device can be performed by the confidence region lock processor 215.

If the lock state update request is received by the confidence region lock processor 215 at operation 502, the confidence region lock processor 215 proceeds to operation 504 and signs the lock state update request by using a device unique key of an electronic device loaded in the confidence region as described with operation 430 of FIG. 4. A method of signing specific data with a certificate or a specific key is already well known, and thereby the present disclosure is not limited to the method of signing.

If the signing is completed, the confidence region lock processor 215 transmits the signed lock state update request and a certificate of the electronic device 200 such as a unique key of the electronic device to the lock processor 214 at operation 506. Like this, the confidence region lock processor 215 driven in the confidence region performs the operation of signing received information with a predetermined key in the confidence region and providing a device certificate for the lock processor 214.

If the signed lock state update request and signed certificate are received at operation 506, the lock processor 214 generates a lock state control request message including the received information at operation 508. Like this, the generated lock state control request message includes the signed lock state update request and device certificate, and may further include the following information.

(1) Lock state information: Information for indicating a lock/unlock state.

(2) International Mobile Equipment Identity (IMEI) information: Unique identification information assigned to each electronic device produced by manufacturers according to the guideline of World Mobile Congress (WMC) which is transmitted by hashing or encrypting in order to protect user's privacy.

(3) Timestamp: Time information from which a receiver can identify a transmission time of a lock state control request message.

(4) R1 (first random value): Random value generated with a predetermined number of digits in order to protect a lock state control request message from a hacker.

Here, the lock state information included in a lock state control request message to indicate a lock/unlock state may be divided into 2 cases. The first case is setting a lock state to restrict an external communication when the electronic device 200 is lost. In this case, the lock state information generated by the lock processor 214 of the electronic device 200 and included in the lock state control request message may have a unlock state. Namely, the lock state information may indicate an unlock state as the current state of the electronic device 200. The second case is releasing a lock when the lost electronic device 200 is reclaimed. In this case, the lock state information generated by the lock processor 214 of the electronic device 200 and included in the lock state control request message may have a lock state. At this time, the lock state information may have a lock state because the current state of the electronic device 200 is regarded as a lost state. Like this, the lock state control request message generated at operation 508 may include information for indicating the current lock/unlock state of the electronic device 200.

As described above, the lock state control request message generated by the lock processor 214 may have the following contents listed in Table 1.

TABLE 1

| Name | Content |
|---|---|
| Lock state update request | Request for changing lock state |
| Sign (Lock state update request) | Signed lock state update request |
| Device Cert | Authentication certificate of electronic |
| | device |
| Lock/Unlock state | State of locking and unlocking |
| IMEI | Unique identifier |
| Timestamp | Time information |
| R1 | First random value |

The generated lock state control request message is transmitted to the service provider server 10 through a specific network such as a mobile communication network 40 at operation 510. Another network can be used if the mobile communication network 40 cannot be used. At this time, messages transmitted to the network can be protected through a security communication such as Secure Sockets Layer (SSL)/Token Key Service (TKS).

If the lock state control request message is received at operation 510, the service provider server 10 verifies the lock state control request message at operation 512. The verification of the lock state control request message can be performed when the following preconditions are satisfied.

### Precondition 1

The first case is that a user requests for unlocking an electronic device to use the electronic device. In this case, changing a state of a corresponding electronic device must be approved by the service provider server 10 through user authentication.

### Precondition 2

When locking an electronic device is requested by a user or a service provider, user authentication must be completed and changing a state of a corresponding electronic device must be approved by the service provider server 10. The user may request for locking the electronic device in several cases, for example, in a case that the electronic device is lost, in a case that the user doesn't want to receive a service from a corresponding service provider, or in a case that the user wants to restrict use of the electronic device. Further the service provider can request for locking an electronic device in several cases, for example, in a case that a prepaid telephone charge is run out, in a case that an electronic device is not returned after a lease contract with a user is terminated, or in a case that a special request for locking is received from a user.

Under one of the above 2 preconditions, the service provider server 10 verifies the lock state control request message at operation 512. An electronic device certificate (device cert) included in the lock state control request message transmitted from the electronic device 200 at operation 500 is firstly verified. The device cert transmitted from the electronic device 200 is signed with a manufacturer public key as illustrated in FIG. 4, and thereby the device cert can be verified by using the manufacturer public key included in in the manufacture public key root cert at operation 420 of FIG. 4.

If verification of the device cert is completed, a signature made by the confidence region lock processor 215 of the electronic device 200 can be verified by using the public key included in the device cert. Like this, the operation 512 in the service provider server 10 is performed through 2 times of verification.

Subsequently, the service provider server 10 identifies the aforementioned preconditions at operation 512. The service provider server 10 identifies whether the lock state update request includes contents approved by a customer service center through an online or offline service. If the lock state update request includes approved contents, the service provider server 10 generates a lock state update command at operation 512. Here, the service provider server 10 signs the lock state update command with a private key. The private key may be same as the service provider public key described in FIG. 4. Examples of the signed lock state update command are listed in Table 2.

TABLE 2

| Name | Content |
|---|---|
| R1 | First random value |
| R2 | Second random value |
| Start Date | Start Date |
| End Date | End Date |
| Lock command/Unlock command | Lock command/Unlock command |
| Signature by private key | Signature information |

In Table 2, R1 indicates a random value generated in the electronic device and R2 indicates a random value generated in the service provider server 10. A validity period of the provided command may be set by determining a start date and an end date. If limitation of the validity period is unnecessary, the end date may be set with a predetermined value or may be removed. A lock or unlock command is used for locking or unlocking the electronic device 200. Lastly, data singed in the service provider server 10 may be included in order to secure reliability.

If the lock state update command is generated, the service provider server 10 transmits the generated lock state update command to the electronic device 200 at operation 514.

If the lock state update command is received at operation 514, the lock processor 214 of the electronic device 200 transmits the lock state update command to the CP 213 at operation 516.

If the lock state update command is received at operation 516, the CP 213 verifies the lock state update command and changes a device state according to the lock state update command at operation 518.

If the lock state update command is received at operation 516, the CP 213 can verify a signature included in the lock state update command because the CP 213 has a service provider public key cert loaded by receiving from the service provider as described in FIG. 4.

The reason why the verification is different for the confidence region lock processor 215 driven in the confidence region (trust zone) of the AP 211 and for the CP 213 is because the confidence region lock processor 215 driven in the confidence region (trust zone) of the AP 211 provides reliability by itself For example, the confidence region of the AP 211 can safely store a key and sign by using the key, and thereby can preserve integrity software-wise. The CP 213 can further preserve the integrity software-wise because a certificate provided by the service provider is loaded in firmware form.

Like this, the confidence regions of AP 211 and the CP 213 can respectively secure reliability, however the AP 211 and the CP 213 allocate different confidence regions than each other. Therefore, the AP 211 and the CP 213 can individually obtain reliability or not. In order to secure the reliability between the AP 211 and the CP 213, a separate routine for securing reliability must be included, which is not described in the present disclosure. If a separate procedure is necessary for securing between the AP 211 and the CP 213, more keys and certificates must be included and the procedure becomes complicated.

If the AP 211 and the CP 213 individually have different confidence regions in an electronic device and the electronic device is controlled by securing reliability from one of the components, the integrity cannot be preserved. However, if the present disclosure is applied, the electronic device can be controlled by providing integrity even though the reliabilities of both components are not secured. Further, the procedure becomes simple because a separate operation is unnecessary to secure the reliabilities of both components.

By applying the method, apparatus, and system according to the present disclosure, an illegal use of an electronic device that supports wireless communication can be protected and a control of locking an electronic device by a mobile communication subscriber can be performed directly or remotely. Further, by using the method and apparatus, an illegal use of the electronic device can be prevented by locking an electronic device through each confidence region in the electronic device that supports wireless communication and having different confidence regions.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling a lock state in an electronic device supporting wireless communication, the method comprising:
signing a lock state update request by using a unique key loaded in a confidence region of the electronic device when a lock state change is requested;
generating a lock state control request message including the lock state update request, the signed lock state update request, and a certificate of the electronic device;
transmitting the generated lock state control request message to a service provider server;
authenticating a lock state update command in a communication processor of the electronic device; and
updating a state of the communication processor according to the lock state update command when the lock state update command is received from the service provider server.

2. The method of claim 1, wherein the lock state update request is received from one of the service provider server and a user input module of the electronic device.

3. The method of claim 1, wherein the certificate of the electronic device is signed with a manufacturer public key.

4. The method of claim 1, wherein the lock state control request message further comprises information indicating lock/unlock states of the electronic device, unique identification information assigned to each of electronic devices, time information of generating the lock state control request message, and a randomly generated first random value.

5. The method of claim 4, wherein the lock state update command comprises the first random value, a second random value randomly generated by the service provider server, an expiration period, one of a lock and an unlock command, and data signed by the service provider server.

6. The method of claim 1, wherein the authenticating of the lock state update command is performed by authenticating a signature included in the lock state update command received from the service provider server by using a service provider public key cert which the communication processor received and loaded from the service provider server.

7. An apparatus for controlling a lock state in an electronic device, the apparatus comprising:
a communication module configured to communicate with a service provider server; and
an application processor configured to sign a lock state update request by using a unique key loaded in a confidence region of the electronic device when a lock state change is requested, to generate a lock state control request message including the lock state update request, the signed lock state update request, and a certificate of the electronic device, and to transmit a lock state update command to a communication processor when the lock state update command is received,
wherein the communication processor is configured to control to generate the lock state control request message generated by the application processor to the service provider server through the communication module, to authenticate the lock state update command through a pre-loaded certificate provided by the service provider server when the lock state update command is received, and to change a lock state according to the lock state update command when the lock state update command is authenticated.

8. The apparatus of claim 7, wherein the application processor comprises:
a lock processor configured to transmit the lock state update command to a confidence region when a lock state change of the electronic device is requested, to generate a lock state control request message when the lock state update request, the signed lock state update request, and the certificate of the electronic device are received from the confidence region, and to drive in a non-confidence region to transmit the lock state update command to the communication processor, when the lock state update command is received; and
a confidence region lock processor configured to sign the lock state update request by using a pre-loaded unique key of the electronic device when the lock state update request is received from the lock processor, and to transmit the lock state update request, the signed lock state update request, and the certificate of the electronic device to the lock processor.

9. The apparatus of claim 8, wherein the communication processor is further configured to load the certificate of the electronic device provided by the service provider server as firmware in a binary form.

10. The apparatus of claim 8, further comprising a user input module configured to provide user input information by detecting a user input,
wherein the lock state update request is input by one of the service provider server and a user input module of the electronic device.

11. The apparatus of claim 8, wherein the certificate of the electronic device is signed with a manufacturer public key.

12. The apparatus of claim 8, wherein the lock state control request message further comprises information indicating lock/unlock states of the electronic device, unique identification information assigned to each of electronic devices, time information of generating the lock state control request message, and a randomly generated first random value.

13. The apparatus of claim 12, wherein the lock state update command comprises the first random value, a second random value randomly generated by the service provider server, an expiration period, one of a lock and an unlock command, and data signed by the service provider server.

14. The apparatus of claim 8, wherein communication processor is further configured to authenticate the lock state update command by authenticating a signature included in the lock state update command received from the service provider server by using a service provider public key cert which the communication processor received and loaded from the service provider server.

15. A system for controlling a lock state in an electronic device, the system comprising:
an electronic device; and
a service provider server,
wherein the electronic device comprises:
a communication module configured to communicate with the service provider server; and
an application processor configured to sign a lock state update request by using a unique key loaded in a confidence region of the electronic device when a lock state change is requested, to generate a lock state control request message including the lock state update request, the signed lock state update request, and a certificate of the electronic device, and to transmit a lock state update command to a communication processor when the lock state update command is received,
wherein the communication processor is configured to control to transmit the lock state control request message generated by the application processor to the service provider server through the communication module, to authenticate the lock state update command through a pre-loaded certificate provided by the service provider server when the lock state update command is received, and to change a lock state of the electronic device according to the lock state update command when the lock state update command is authenticated, and
wherein the service provider server comprises:
a subscriber database configured to store the certificate of the electronic device provided by a manufacturer producing the electronic device and a public key provided by the service provider server; and
a server configured to verify the lock state control request message by using the certificate stored in the subscriber database when the lock state control request message is received through a network, and to generate the lock state update command for changing the lock state of the electronic device in order to transmit the lock state update command to the electronic device through the network when the lock state control request message is verified.

16. The system of claim 15, wherein the application processor comprises:
a lock processor configured to transmit the lock state update command to a confidence region when a lock state change of the electronic device is requested, to generate a lock state control request message when the lock state update request, the signed lock state update request, and the certificate of the electronic device are received from the confidence region, and to drive in a non-confidence region to transmit the lock state update command to the communication processor, when the lock state update command is received; and
a confidence region lock processor configured to sign the lock state update request by using a pre-loaded unique key of the electronic device when the lock state update request is received from the lock processor, and to transmit the lock state update request, the signed lock state update request, and the certificate of the electronic device to the lock processor.

17. The system of claim 16, wherein the communication processor is further configured to load the certificate of the electronic device provided by the service provider server as firmware in a binary form.

18. The system of claim 15, wherein the lock state control request message further comprises information indicating lock/unlock states of the electronic device, unique identification information assigned to each of electronic devices, time information of generating the lock state control request message, and a randomly generated first random value.

19. The system of claim 15, wherein the lock state update command comprises the first random value, a second random value randomly generated by the service provider server, an expiration period, one of a lock and an unlock command, and data signed by the service provider server.

20. The system of claim 15, wherein the communication processor is further configured to authenticate the lock state update command by authenticating a signature included in the lock state update command received from the service provider server by using a service provider public key cert which the communication processor received and loaded from the service provider server.
